(19) United States
(12) Patent Application Publication
(10) Pub. No.: US 2014/0338516 A1
(43) Pub. Date: Nov. 20, 2014

(54) STATE DRIVEN MEDIA PLAYBACK RATE AUGMENTATION AND PITCH MAINTENANCE

(71) Applicant: MICHAEL J. ANDRI, PORTLAND, OR (US)

(72) Inventor: MICHAEL J. ANDRI, PORTLAND, OR (US)

(21) Appl. No.: 14/281,732

(22) Filed: May 19, 2014

Related U.S. Application Data
(60) Provisional application No. 61/825,075, filed on May 19, 2013.

(51) Int. Cl. G10H 1/40; A63B 69/00

(52) U.S. Cl. CPC G10H 1/40; A63B 69/00; A63B 2220/803
USPC 84/612

(57) ABSTRACT

An electronic device obtains a media content item that includes an audio component. The electronic device obtains inertial sensor measurements indicating physical movement of the electronic device. The electronic device selects a target tempo for presentation of the audio component in which the target tempo is based, at least in part, on the inertial sensor measurements. The electronic device presents the audio component at the target tempo while maintaining pitch of one or more frequency components of the audio component at a native pitch or within a substantially un-shifted state relative to the native pitch of the one or more frequency components.

### CROSS-REFERENCE TO RELATED APPLICATION

The present application claims priority to U.S. Provisional Patent Application Ser. No. 61/825,075, titled STATE DRIVEN MEDIA PLAYBACK RATE AUGMENTATION AND PITCH MAINTENANCE, filed May 19, 2013, the entire contents of which are incorporated herein by reference in their entirety for all purposes.

### BACKGROUND

Electronic devices such as mobile media players, mobile computers, and mobile communication devices enable users to access and consume media content. Many of these electronic devices enable users to download or stream media content over wireless communication networks. A reduced form factor size and weight of such electronic devices allows users to carry these electronic devices wherever they go.

### SUMMARY

In one example, an electronic device obtains a media content item that includes an audio component. The electronic device obtains inertial sensor measurements indicating physical movement of the electronic device. The electronic device selects or otherwise identifies a target tempo for presentation of the audio component. The target tempo may be based, at least in part, on the inertial sensor measurements indicating, for example, a pace or cadence of a physical activity performed by a human subject. The electronic device presents at least a portion of the audio component at the target tempo while maintaining pitch of one or more frequency components of the portion of the audio component at a native pitch, within a substantially un-shifted state relative to the native pitch of the one or more frequency components, or within a defined threshold range of the native pitch.

In another example, an electronic device receives at least a portion of a media content item over a communications network and observes an operating condition of the communications network. The electronic device processes the portion of media content item according to an altered playback mode under select conditions of the communication network. The altered playback mode reduces a playback rate for at least a portion of the media content item relative to a native playback rate of the portion of the media content item. The electronic device maintains pitch of an audio component of the media content item at a native pitch or within a substantially un-shifted state relative to the native pitch of the audio component. The electronic device presents at least the portion of the media content item according to the altered playback mode with the reduced playback rate while maintaining the pitch of the corresponding audio component at the native pitch, within a substantially un-shifted state, or within a defined threshold range of the native pitch.

### BRIEF DESCRIPTION OF DRAWINGS

FIG. 1 is a schematic diagram depicting an example electronic device.

FIG. 2 is a flow diagram depicting an example method for an electronic device.

FIG. 3 is a schematic diagram depicting examples of target tempo and pitch as compared to native tempo and pitch.

FIG. 4 is a schematic diagram depicting an example computing system.

FIG. 5 is a flow diagram depicting another example method for an electronic device.

FIG. 6 is a schematic diagram depicting an example relationship between playback rate and a condition of a communication network.

FIG. 7 is a schematic diagram depicting an example of playback rate varying responsive to a condition of a communication network.

FIG. 8 is a schematic diagram depicting example graphs of elevation (or level of effort) vs. target tempo.

FIG. 9 is a schematic diagram depicting an example processing pipeline.

FIGS. 10-13 are schematic diagrams depicting example graphs of buffer status, connection speed, and playback rate.

### DETAILED DESCRIPTION

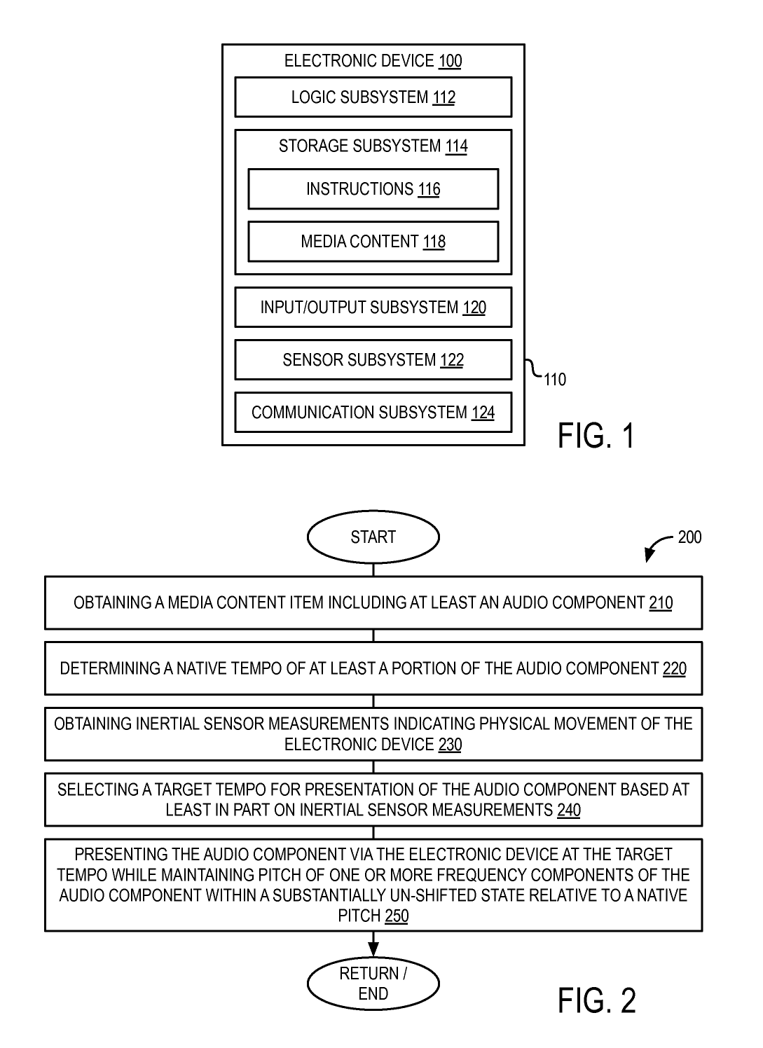

FIG. 1 is a schematic diagram depicting an example electronic device 100. Electronic device 100 may include a device body 110, a logic subsystem 112 including one or more processor devices and/or logic machines, a storage subsystem 114 including one or more storage devices (e.g., hardrive, memory device, etc.), an input/output subsystem 120 including one or more input devices and/or one or more output devices, a sensor subsystem 122 including one or more sensor devices, and a communication subsystem 124.

Electronic device 100 may take the form of a computing device, a media player device, an electronic sports wristwatch or band, electronic sensor element that communicates with another electronic device, or other suitable electronic device. Electronic device 100 may take the form of a mobile electronic device, such as a mobile computing device, mobile media player, or wearable computing device, for example.

Logic subsystem 112 may execute instructions 116 stored in or otherwise residing at storage subsystem 114 to perform or otherwise enact the methods, processes, or functions described herein. Storage subsystem 114 may further store or otherwise hold data in a data store, including media content 118 as well as other forms of information, for example.

Input devices of input/output subsystem 120 may include a touch-screen display, a keyboard, a keypad, an optical camera, a microphone, a pointing device such as a computer mouse or controller, or other suitable input device. Output devices of input/output subsystem 120 may include a graphical display such as the previously described touch-screen display, an audio speaker, or other suitable output devices, including, for example, one or more audio jacks for transmitting audio information from electronic device 100 to an external audio receiver, amplifier, audio headphones, and/or audio speaker.

Sensor devices of sensor subsystem 122 may include one or more inertial sensors, one or more optical sensors, or other suitable type of sensor. Inertial sensors may include or refer to gyroscope sensors, motion sensors, accelerometers, vibration sensors, etc. that provide an indication of physical movement of the electronic device. Sensor subsystem may be used, for example, to detect or otherwise measure a cadence of a human subject as a user of the electronic device. For example, the electronic device may be carried with the user while performing a physical activity such as walking, running, cycling, rowing, skiing, etc.

Communication subsystem 124 may include one or more wireless receivers, transmitters, and/or transceivers, and associated hardware for communicating wirelessly with one or more other wireless communication devices via one or more wireless protocols. Communication subsystem 124 may include a GPS receiver or other suitable GNSS. Communication subsystem 124 may also support wireless communications via Bluetooth or other near-field wireless communications protocol, cellular wireless communication protocols (e.g., LTE 4G, 3G, etc.), Wi-Fi, Wi-Max, etc.

FIG. 2 is a flow diagram depicting an example method 200 for an electronic device. As one example, method 200 may be performed by previously described electronic device 100 of FIG. 1.

At 210, the method includes obtaining a media content item including at least an audio component. As one example, the media content item may be retrieved from a storage subsystem of the electronic device and/or may streamed or downloaded from a network service over a wireless or wired communications link.

At 220, the method includes determining a native tempo of at least a portion of the audio component. As one example, the native tempo of the media content item may indicated by meta data of the media content item. As another example, the media content item may be processed or otherwise examined by the electronic device to identify the native tempo. The native tempo may refer to a tempo of at least one aspect of the audio component. As one example, the native tempo may refer to the predominant tempo of the audio component. The audio component may include or take the form of a song or a portion thereof, for example.

At 230, the method includes obtaining inertial sensor measurements indicating physical movement of the electronic device. As one example, the inertial sensor measurements may be obtained via one or more inertial sensors of a sensor subsystem of the electronic device. The inertial sensor measurements may take the form of a time-series of inertial sensor measurements indicating physical movement of the electronic device over a period of time. For example, a human subject that carries the electronic device may be engaged in a physical activity such as walking, running, cycling, etc. Inertial sensor measurements may include sensor measurements obtained from one or more accelerometers, gyroscopes, motion sensors, tilt sensors, linear motion sensors, and/or other suitable sensors.

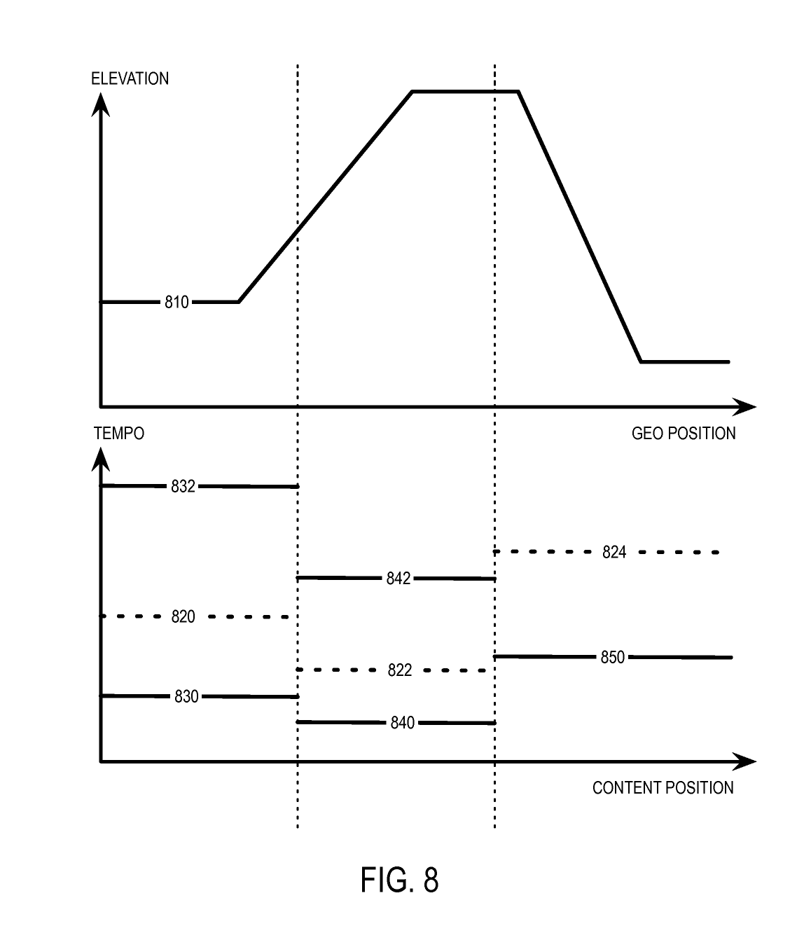

At 240, the method includes selecting a target tempo for presentation of the audio component. The target tempo may be based, at least in part, on the inertial sensor measurements. As one example, selecting the target tempo may further include determining a predominant cadence of a physical activity performed by a user based, at least in part, on the inertial sensor measurements. For example, the target tempo may be set to an integer multiple of (greater multiple of or lesser divisor of) the predominant cadence—e.g., 1× (1:1), 2× (1:2), 3×(1:3), or ½ (2:1), ⅓ (3:1), etc. In at least some implementations, selecting the target tempo may further include determining whether a prescriptive tempo or descriptive tempo setting has been engaged by a user, as will be described in further detail herein. In at least some implementations, selecting a target tempo may be based on current and/or predicted future/approaching changes in elevation and/or current or predicted future/approaching geographic position of the electronic device as will be described in greater detail herein with reference to FIG. 8.

At 250, the method includes presenting the audio component via the electronic device (e.g., outputting the audio component via an audio speaker) at the target tempo while maintaining pitch of one or more frequency components of the audio component at a native pitch, within a substantially un-shifted state relative to the native pitch of the one or more frequency components, or within a defined threshold range of the native pitch. The process of maintaining the native pitch or reducing an amount pitch shift due to changing the tempo of the audio component may be referred to as pitch correction. For example, In at least some implementations, method 200 may further include processing the media content item at the electronic device to increase or decrease the native tempo toward the target tempo, and applying pitch correction to reduce deviations in pitch of the one or more frequency components relative to the native pitch otherwise due to the increase or decrease of the native tempo toward the target tempo.

In at least some implementations, method 200 may further include obtaining a user input indicating a target pace for a physical activity performed by a user. In such case, selecting the target tempo may include determining a current pace for the physical activity performed by the user based, at least in part, on the inertial sensor measurements. As one example, the target tempo may be increased if the current pace is less than the target pace to guide the user back toward the target pace by increasing their cadence. As another example, the target tempo may be decreased if the current pace is greater than the target pace to guide the user back toward the target pace by reducing their cadence.

In at least some implementations, method 200 may further include obtaining a predefined physical activity session indicating a target pace that varies over time for a physical activity performed by a user. In such case, determining the target tempo may include determining a current pace for the physical activity performed by the user based, at least in part, on the inertial sensor measurements. The target tempo may be varied if current pace deviates from the target pace by more than a threshold amount, while continuing to maintain pitch of one or more frequency components of the portion of the audio component within the substantially unshifted state relative to the native pitch of the one or more frequency components.

In at least some implementations, method 200 may further include obtaining a media library including the media content item, and one or more other media content items. Obtaining a media content item may include retrieving the media content item from a storage device residing on-board the electronic device or from a remote source over a communications network or communications link. Similarly, a media library may be obtained by retrieving the media library or a portion thereof from a storage device residing on-board the electronic device or from a remote source over a communications network or communications link.

In such case, the media library may be filtered based, at least in part, on a respective native tempo of an audio component of each of the media content items of the media library to obtain a subset of the media content items having a respective native tempo within a tempo range of the target tempo. The media content item may be selected from the subset of media content items. As one example, a list of the subset of media content items may be presented via a graphical display of the electronic device. A user input may be directed at the list indicating a user-selection. The media content item may be selected from the subset of media content items by selecting the media content item indicated by the user-selection.

Pitch correction may not be applied in some examples or may be reduced. As one example, responsive to the existence of a threshold difference between the native tempo and the target tempo, method 200 may further include adjusting pitch of the audio component by an amount that is greater than the substantially unshifted state and less than a pitch deviation amount corresponding to the target tempo.

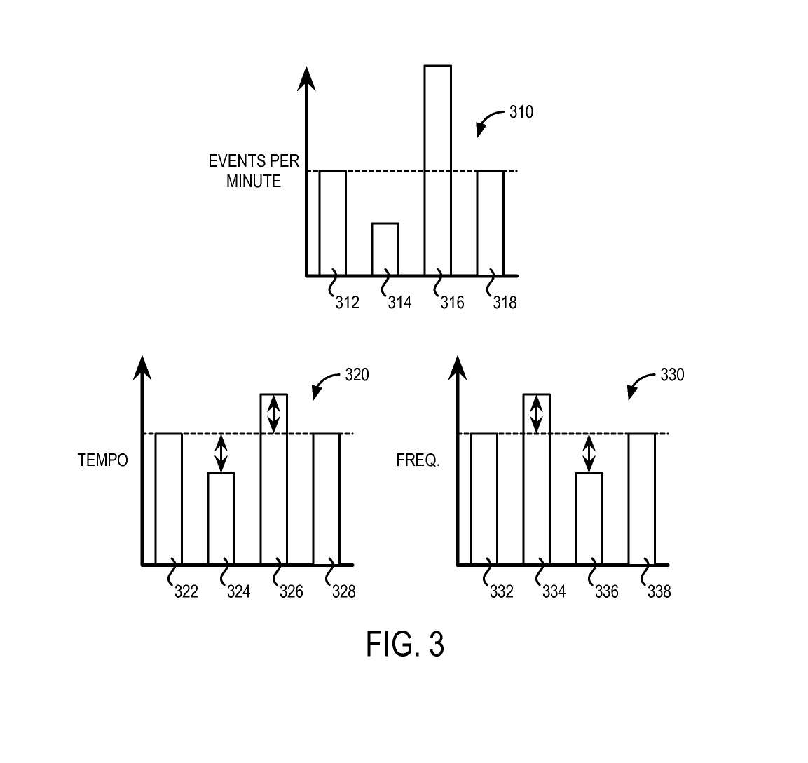

FIG. 3 is a schematic diagram depicting examples of target tempo and pitch as compared to native tempo and pitch for a number of example use-scenarios involving events per minute for a sample media content item that includes an audio component. Events per minute are depicted at 310 for example use-scenarios 312, 314, 316, and 318. Events per minute may refer to a cadence of a human activity, such as steps per minute, or other suitable activity. Events per minute example 312 may refer to 120 steps per minute. Events per minute example 314 may refer to 60 steps per minute. Events per minute example 316 may refer to 180 steps per minute. Events per minute example 318 may also refer to 120 steps per minute.

Tempo of an audio component of a media content item (e.g., a song) is depicted at 320 for example use-scenarios 322, 324, 326, and 328, which correspond respectfully to use-scenarios 312, 314, 316, and 318. For example, at 322, the native tempo of the audio component matches the events per minute at 312 (e.g., 120 steps per minute and 120 beats per minute). Hence, adjustment to the tempo may not be performed.

Frequency of the audio component of the media content item is depicted at 330 for use-scenarios 332, 334, 336, and 338, which correspond respectfully to use scenarios 312/322, 314/324, 316/326, 318/328. Use-scenario 332 depicts a native frequency of the example audio component of the media content item. Because the events per minute at 312 matches or substantially matches the native tempo at 322 (or is an integer multiple thereof), the frequency at which the audio component is present to the user is the same as the native frequency—i.e., pitch correction is not required or performed.

If, however, in use-scenario 314, the events per minute is less than at 312, then the target tempo of the audio component may be reduced downward at 324 relative to 322 to more closely match or match (or match an integer multiple thereof) of the events per minute. Because the tempo is slowed at 324, the frequency component would otherwise be presented and be perceived by the user at a lower frequency if pitch correction was not applied. However, by applying pitch correction as indicated schematically at 334 to increase the pitch relative to the lower frequency that would otherwise occur to more closely match the native frequency at 332, the output of the presented audio component output by the electronic device may more closely resemble or match the native frequency as indicated by presented frequency 338.

Conversely, at 316, the events per minute is greater than at 312, hence, the tempo may be increased at 326 relative to the native tempo, and pitch correction may be applied to compensate as indicated at 336 by a lowering of the frequency that would otherwise occur to maintain the native frequency as indicated by the output at 338.

In some cases, an audio component of a media content item may have two or more portions each having a different native tempo. For example, a song may have an intro portion followed by a chorus portion followed by a bridge portion that have different native tempos. It will be understood that an audio component may have one or more native tempos that may vary over playback of the audio component.

As a non-limiting example, the native tempo of a song may be 96 beats per minute, the cadence of a runner may be running at 180 steps per minute or a target cadence may be set to 180 steps per minute. In this example, the song may be sped up to 180 beats per minute while at least partially or fully correcting for pitch change that would otherwise occur. As another example, the song may be slowed down to 90 beats per minute, which is an integer multiple of 180 steps per minute, while at least partially or fully correcting for pitch change that would otherwise occur.

It will be understood that in some examples or implementations, tempo may be adjusted toward the closest integer multiple of the cadence or other suitable events per minute. For example, if the BPM is 90 and the cadence is 100, the BPM may be adjusted to 100. If, however, the BPM is 52 and the cadence is 100, the BPM may be adjusted to 50 (½ of 100), or if the BPM is 195, and the cadence is 100, the BPM may be adjusted to 200 (2× of 100). In at least some examples, a predetermined factor or threshold may be used to determine which direction to adjust relative to a 1:1 relationship between the cadence and the target tempo or an unequal integer multiple (e.g., 1:2 or 2:1, etc. of the cadence. For example, the factor or threshold may be ⅔ or ⅓ or other suitable value of the difference between the 1:1 relationship and the unequal integer multiple. In this case, for example if the factor or threshold is ⅔, and if the cadence is 100, and the native tempo is 160 (less than ⅔ of the difference between the 1:1 relationship of 100 and the 1:2 relationship of 200) the target tempo would be set to 100. In this same example, if the native tempo is instead 169 (greater than ⅔ of the difference between the 1:1 relationship of 100 and the 1:2 relationship of 200) the target tempo would be set to 200. Here, the ⅔ factor or threshold serves to favor a 1:1 relationship since it more closely matches the cadence in contrast to a ½ factor or threshold that would not favor either the 1:1 or the unequal integer multiple.

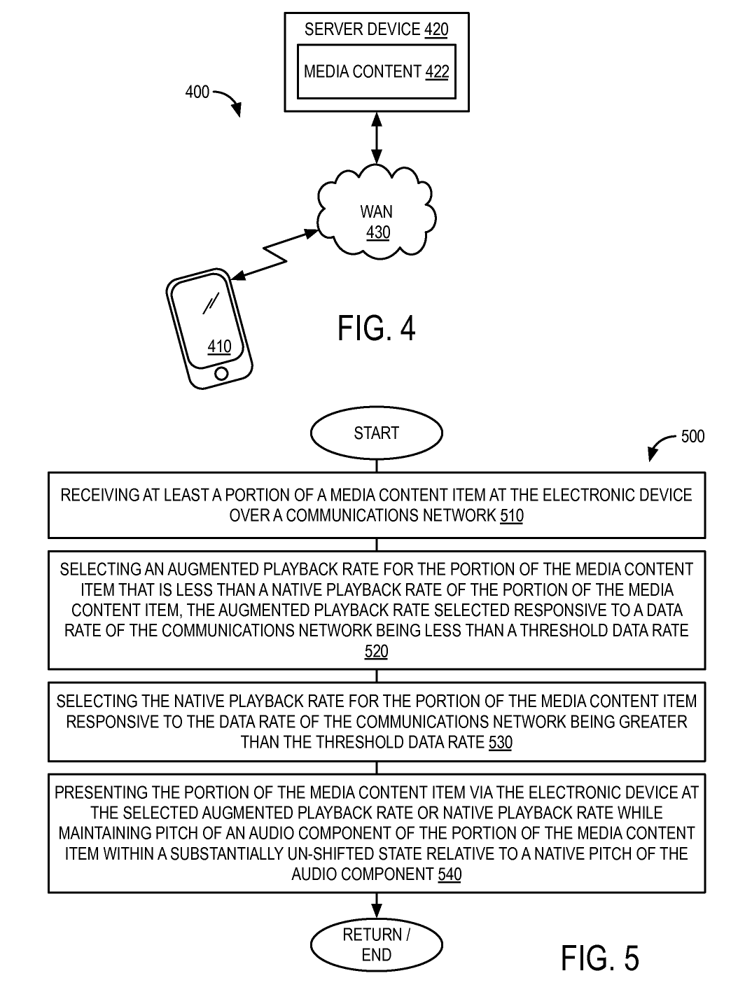

FIG. 4 is a schematic diagram depicting an example computing system 400 that includes the example electronic device 100 of FIG. 1. Computing system 400 further includes one or more computing devices (e.g., server device 420) that may communicate with electronic device 100 via a communications network 430. Communications network 430 may take the form of a wide area network (e.g., the Internet and/or mobile data network), a local area network (e.g., an Intranet), and/or a personal area network.

Computing devices such as server device 420 may take the form of a network server from which electronic device 100 may request and receive information resources. As one example, these information resources may include a media content item.

FIG. 5 is a flow diagram depicting another example method 500 for an electronic device. As one example, method 500 may be performed by previously described electronic device 100 of FIG. 1 within computing system 400 of FIG. 4.

At 510, the method includes receiving at least a portion of a media content item at the electronic device over a communications network.

At 520, the method includes selecting an augmented playback rate for the portion of the media content item that is less than a native playback rate of the portion of the media content item. The augmented playback rate may be selected responsive to a data rate of the communications network being less than a threshold data rate.

At 530, the method includes selecting the native playback rate for the portion of the media content item responsive to the data rate of the communications network being greater than the threshold data rate.

At 540, the method includes presenting the portion of the media content item via the electronic device at the selected augmented playback rate or the native playback rate while maintaining pitch of an audio component of the portion of the media content item within a substantially un-shifted state relative to a native pitch of the audio component.

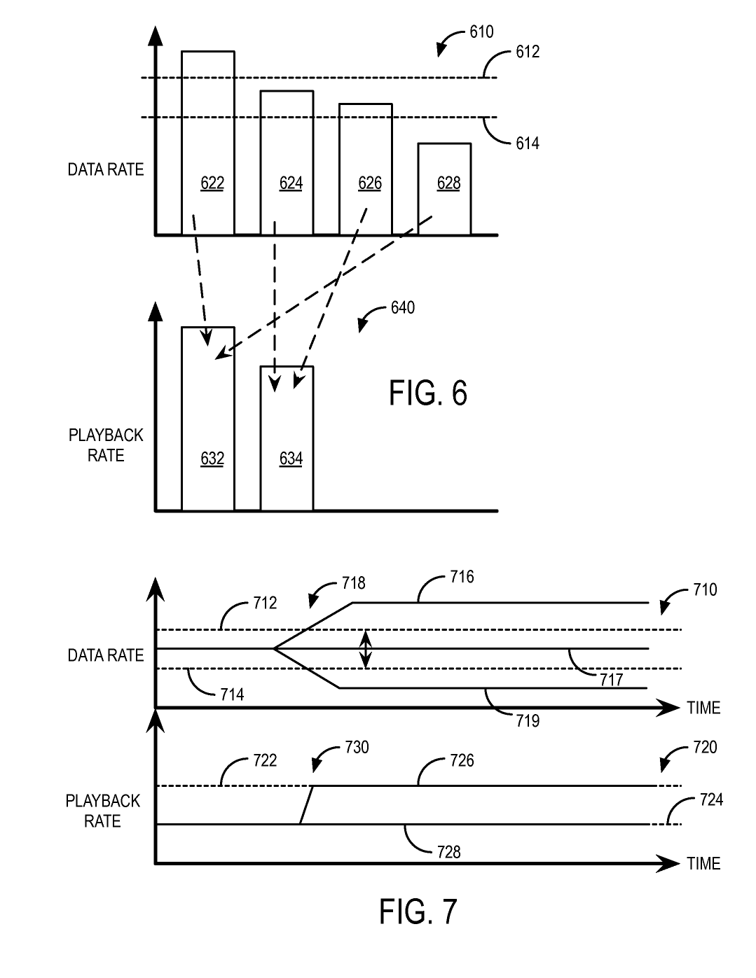

FIG. 6 is a schematic diagram depicting an example relationship between playback rate and a condition of a communication network. As one example, the condition may include a data rate of the communication network, such as a data rate at which a media content item is received or can be received over the communication network. As another example, the condition may include a data rate variability of the communication network.

Chart 610 includes four example data rates 622, 624, 626, and 628. Data rate 622 is greater than an upper data rate threshold 612. Data rates 624 and 626 are less than upper data rate threshold 612 and greater than a lower data rate threshold 614. Data rate 628 is less than lower data rate threshold 614.

Chart 640 includes two example playback rates 632 and 634. Playback rate 632 is greater than playback rate 634. As one example, playback rate 632 corresponds to a native playback rate and playback rate 634 corresponds to an augmented playback rate.

As one example, data rate 622 and/or data rate 628 that are outside of a band defined by upper data rate threshold 612 and lower data rate threshold 614 may result in a media content item received over the communication network to be presented at playback rate 632. By contrast, data rate 624 and data rate 626 that are within the band defined by upper data rate threshold 612 and lower data rate threshold 614 may result in a media content item received over the communication network to be presented at playback rate 634. In alternative scenarios, data rate 628 that is less than the lower data rate threshold 614 may result in a media content item received over the communication to be presented at data rate 634.

The selection of the native playback rate or augmented playback rate may be based on an amount of data of the media content item buffered at the electronic device that is receiving the media content item over the communication network and/or may be based on an a current playback position of the media content item. Additionally or alternatively, an amount of reduction in the playback rate of the augmented playback rate relative to the native playback rate may be based on an amount of data of the media content item buffered at the electronic device that is receiving the media content item over the communication network and/or may be based on an a current playback position of the media content item.

FIG. 7 is a schematic diagram depicting an example of playback rate varying responsive to a condition of a communication network. As one example, the condition may include a data rate of the communication network, such as a data rate at which a media content item is received or can be received over the communication network. As another example, the condition may include a data rate variability of the communication network.

Chart 710 includes three example data rates 716, 717, and 719 as compared to time. Data rates 716, 717, and 719 in this example begin within a band defined by an upper data rate threshold 712 and a lower data rate threshold 714. Data rate 716 increases at 718 to a higher data rate than upper data rate threshold 712. Data rate 717 remains within the band defined by upper data rate threshold 712 and lower data rate threshold 714. Data rate 719 decreases at 718 to a lower data rate than lower data rate threshold 714.

Chart 720 includes two example playback rates 726 and 728. Playback rate 726 and playback rate 728 begin at a lower playback rate 724 in this particular example. In other examples, the playback rate may begin at a higher playback rate 722. Higher playback rate 722 may correspond to a native playback rate of a media content item, and lower playback rate 724 may correspond to an augmented playback rate of the media content item. Playback rate 726 increases at 730 to higher playback rate 722. Playback rate 728 remains at lower playback rate 724.

As one example, data rate 716 may correspond to playback rate 726. As another example, data rate 717 may correspond to playback rate 728. As yet another example, data rate 719 may correspond to playback rate 728 or playback rate 726. As previously discussed, the selection of the native playback rate or augmented playback rate may be based on an amount of data of the media content item buffered at the electronic device that is receiving the media content item over the communication network and/or may be based on an a current playback position of the media content item. Additionally or alternatively, an amount of reduction in the playback rate of the augmented playback rate relative to the native playback rate may be based on an amount of data of the media content item buffered at the electronic device that is receiving the media content item over the communication network and/or may be based on an a current playback position of the media content item.

The various concepts described herein may be implemented in combination with feedforward control to provide an enhanced or improved user experience. Information relating to a future or upcoming prescriptive pace or cadence for a human subject or a predicted future or upcoming descriptive pace or cadence for the human subject may be used as feedforward information to inform the selection of a media content item from a library of media content items.

As one example, in a prescriptive pace or cadence scenario, a user may select a predefined physical activity session from a library of predefined physical activity sessions or a user may provide a user input (e.g., a menu selection or specified value) indicating a user-defined target pace or cadence for the physical activity. A predefined physical activity session or user-defined pace or cadence may take the form of computer readable information (e.g., instructions and/or data values) held in a storage subsystem of a computing device or other suitable electronic device, for example. The selected predefined physical activity session or user-defined targets may prescribe a target pace or cadence for the user. This target pace or cadence may vary over time as the user engages in the physical activity session. For example, during an early warm-up phase of the physical activity session, the target pace or cadence of the user may be represented by the value “X”, such as X steps per minute, X pedal turns per minute, X rows per minute, X feet per second, X miles per hour, etc. For a subsequent intermediate phase of the physical activity session, the target pace or cadence may be increased or decreased relative to the value X, and may be represented as the value “Y”. For a final phase of the physical activity session, the target pace or cadence may be increased or decreased relative to the value Y, and may be represented as the value “Z”. Alternatively or additionally, a user may adjust the target pace or cadence by manually increasing or decreasing a pace or cadence value via a user input before or during a physical activity. If, for example, the user is currently engaged in the early warm-up phase of the physical activity session and is listening to an audio content item that has been augmented to provide a playback rate for the target or user's current pace or cadence, and the audio content item is to conclude before or during the subsequent intermediate phase of the physical activity, selection of a subsequent audio content item may be selected for playback based, at least in part, on the target pace or cadence of the subsequent intermediate phase of the physical activity. The subsequent audio content item may be selected, for example, so that the native tempo of the subsequent audio content item approximately matches or is capable of being augmented to approximately match an integer multiple of the target pace or cadence of the subsequent intermediate phase while maintaining native pitch of the subsequent audio content item (e.g., through pitch correction) at the native pitch or within suitable range of the native pitch. This feedfoward approach provides the benefit of reducing the number of times a new media content item must be selected because the target pace or cadence has changed to a value that is outside of the suitable tempo range of a previously selected media content item.

As another example, in a descriptive pace or cadence scenario, inertial sensor measurements may be used to identify the user's pace or cadence during the physical activity. As the user is moving throughout a physical environment or a virtual environment having a physical manifestation in terms of level of effort physically encountered by the user during the physical activity (e.g., treadmill angle, current elevation, or stationary cycle pedal resistance), upcoming or future conditions of the physical or virtual environment (e.g., approaching change in elevation) that are likely to be encountered by the user may be used as feedforward information to predict the user's future pace or cadence based, at least in part, on the user's current and/or past pace or cadence for the current and/or past conditions of the physical or virtual environment. The likelihood of encountering a physical or virtual environment may be determined based on user settings in some examples, such as a predefined path of travel within the physical or virtual environment. For example, a user may be running or cycling on a road in which the user is located at a portion of the road having a particular grade value “A” (e.g., X% grade and direction of travel, however other conditions may be considered such as surface roughness, wind conditions, temperature, humidity, etc.). The upcoming or future conditions of the physical or virtual environment may be identified from GPS data received by the electronic device, stored condition data mapping, and/or stored predefined physical activity sessions. For example, the user may encounter an increased or decreased road grade relative to value A in a mile or other distance up the road for the user's direction of travel. If, for example, the approaching grade of the road increases in the positive direction relative to the current grade, then the user's pace or cadence may be predicted to decrease relative to the current and/or past pace or cadence when the user reaches that approaching grade of the road. Conversely, the user's pace or cadence may be predicted to increase for reductions in grade in the negative direction relative to the user's travel direction. Again, media content to be selected for playback during a period of time that the user approaches and/or reaches that upcoming or future grade of road may be selected so that the media content item approximately matches or is capable of being augmented to approximately match an integer multiple of the predicted future or upcoming pace or cadence while maintaining native pitch of the subsequent audio content item (e.g., through pitch correction) at the native pitch or within suitable range of the native pitch. This feedfoward approach again provides the benefit of reducing the number of times a new media content item must be selected because the target pace or cadence has changed to a value that is outside of the suitable tempo range of a previously selected media content item.

FIG. 8 depicts example graphs comparing a graph of how target tempo may be varied vs. playback position of a media content item and a graph of how elevation encountered by a user over the course of a physical activity may change vs. geographic position of that user. An example elevation 810 is depicted changing vs. geographic position. A descriptive or prescriptive target tempo is depicted at 820 for the elevation encountered by the user for a range of geographic position and content position. In this example, a media content item is played back at a higher tempo 832 that is a multiple of the target tempo while maintaining pitch, a lower tempo 830 that is a multiple divisor of the target tempo while maintaining pitch, or alternatively at the target tempo. As the user approaches an increase in elevation or engages in an increase in elevation for a period of time, a prescriptive or descriptive target tempo 822 may decrease relative to 820, which may result in augmentation of the tempo of the media content item from 832 to 842, or from 834 to 844, while maintaining pitch. Again, tempos 842/844 are integer multiples/divisors of the target tempo. As the user approaches a decrease in elevation or engages in a decrease in elevation for a period of time, a prescriptive or descriptive target tempo 824 may increase relative to 822, which may result in augmentation of the tempo of the media content item from 840 to 850, while maintaining pitch. Again, tempo 850 is an integer multiple (divisor) of the target tempo. Also in this example, a higher multiple may not be selected or utilized because target tempo 850 is above a threshold target tempo.

It will be understood that media content items typically have metadata indicating a native playback length of the media content item. A time of conclusion of playback for a particular media content item may be determined based on the current playback position, the native playback length, and an amount of playback rate augmentation applied to the media content item. The time of conclusion of playback may be updated responsive to changes in the amount of playback rate augmentation and/or seeking/pausing of the media content item by the user. Selection of subsequent media content items for playback may be based on and performed responsive to the time of conclusion of playback for the current media content item undergoing playback as well as the native playback length for the subsequent media content item. For example, a subsequent media content item may be selected based on the ability for that media content item to conclude playback prior to a particular change in a future or upcoming pace or cadence of the user, whether predicted or prescribed.

In a first example use-scenario, an electronic device obtains one or more performance measurements indicating a pace or cadence of a physical activity performed by a human subject. Physical activities performed by the human subject may include, for example, walking, running, jumping, cycling, swimming, climbing, rowing, lifting, interacting with an apparatus, or other physical activity. The electronic device further obtains a media content item that includes an audio component. The electronic device selects or otherwise identifies a target tempo for presentation of the audio component. The target tempo selected or identified by the electronic device may be based, at least in part, on the performance measurements indicating a pace or cadence of a physical activity performed by a human subject, however obtained by the electronic device. The electronic device presents at least a portion of the audio component at the target tempo while maintaining pitch of one or more frequency components of the presented portion of the audio component at either (1) a native pitch, (2) within a substantially un-shifted state relative to the native pitch of the one or more frequency components, or (3) within a defined threshold range of the native pitch. Prescriptive and descriptive modes of operation may be supported by the electronic device. In a prescriptive mode of operation, the target tempo may may be identified or selected to assist the human subject obtain a predefined pace or cadence. In a descriptive mode of operation, the target tempo may be identified or selected to track the actual pace or cadence of the human subject.

The techniques described herein may be used to expand the library of available music content that a user can match to a target cadence (e.g., actual measured cadence or user defined cadence) while also enjoying the music content at the same or similar frequency or plurality of frequency components. For example, if the user has access to a diverse range of music having differing tempos, and has a target cadence of 100 steps per minute, then without application of the techniques described herein, few of the music content items would match or be close to or be an integer multiple of the 100 steps per minute. Or, without application of the techniques described herein, if those unmatching music content items were presented at the target cadence/tempo, then the pitch would sound different than the native pitch. By application of the techniques described herein, the user may access all or more of the music content items while enjoying the music at the native or closer to the native frequency/pitch.

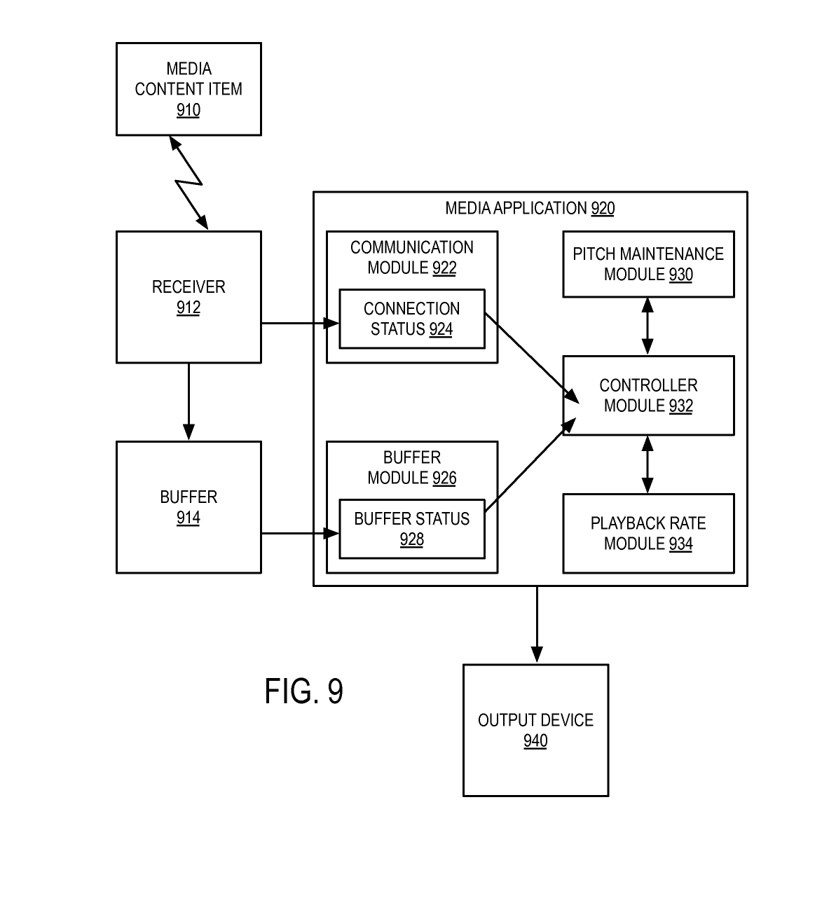

Referring again to FIGS. 4-7, FIG. 9 depicts a non-limiting example of a processing pipeline for selecting a native or augmented playback rate for a media content item responsive to or based on a data rate of a communications network or a download rate of the media content item over the communications network. The processing pipeline of FIG. 9 may form part of device 410 of FIG. 4 or instructions executed by device 410, and may perform method 500 of FIG. 5 or portions thereof, for example.

In FIG. 9, a media content item 910 or a portion thereof is received via a receiver 912. A communication module 922 obtains one or more connection status values 924 for the download or streaming of the media content item 910. The media content item or portions thereof is/are stored in a buffer 914 of a storage device or subsystem, at least during download or streaming. A buffer module 926 obtains one or more buffer status values 928. Buffer status values 928 and/or connection status values 924 are supplied to a controller module 932. Controller module 932 may command a pitch maintenance module 930 to maintain pitch of one or more frequency components of an audio portion of a media content item, while controller module 932 may command playback rate module 934 to increase or decrease the playback rate of the media content item. Controller module 932 may be responsible for implementing previously described method 500 of FIG. 5 or portions thereof, for example. The media content item may be played via an output device 940, in at least some implementations.

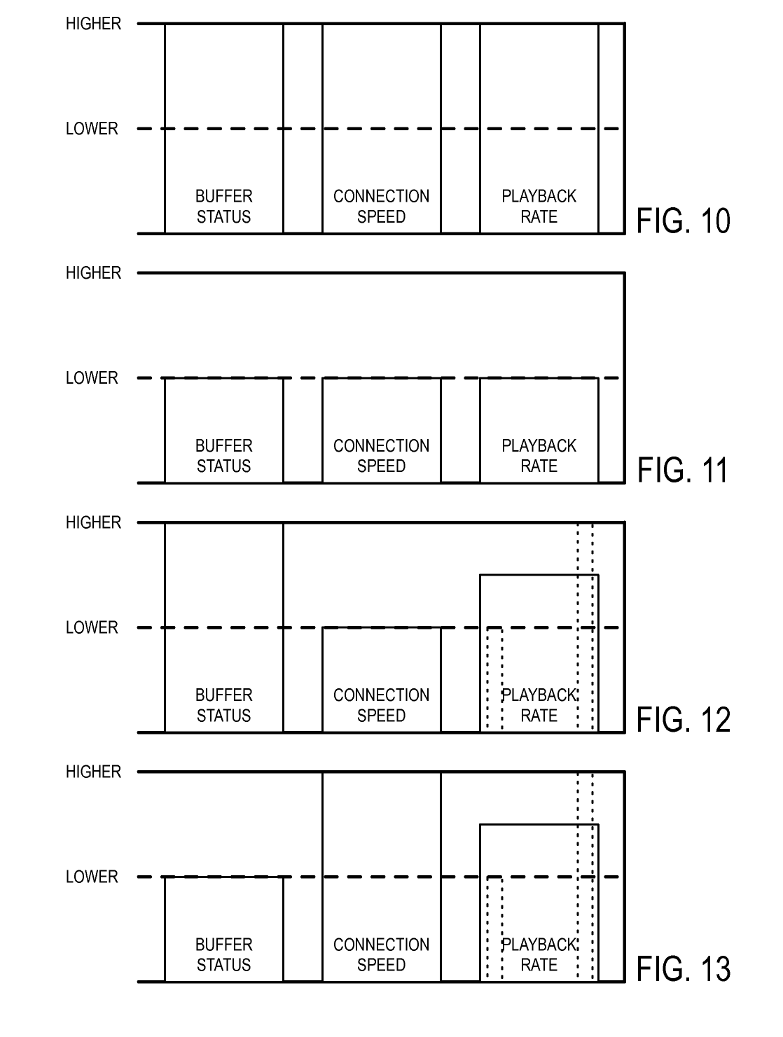

In combination with FIGS. 5 and 9, FIGS. 10-13 depicting non-limiting examples of buffer status, network connection speed, and selected playback rate based on the buffer status and/or connection speed. In FIG. 10, for example, a relatively higher buffer status (e.g., greater data contained in the buffer) and a relatively higher connection speed may result in selection of a higher playback rage (e.g., native playback rate or a higher multiple in the case of implementations of FIG. 2). By contrast, FIG. 11 depicts an example in which a relatively lower buffer status and a relatively lower connection speed may result in selection of a lower playback rate (with pitch maintenance). In FIG. 12, for example, depicts how a higher buffer status and lower connection speed may result in selection of an intermediate playback rate (or alternatively on a higher (e.g., native) or lower playback rate based on mathematically computed timing of delivery of the last portion of the media content item relative to a timing of the end of the media content item playback to ensure that delivery will conclude prior to conclusion of playback). FIG. 13, for example, depicts how a lower buffer status and higher connection speed may result in selection of an intermediate playback rate with pitch maintenance (or alternatively on a higher (e.g., native) or lower playback rate based on a mathematically computed timing of delivery of the last portion of the media content item relative to a time of the end of the media content item playback to ensure that delivery will be completed prior to conclusion of playback). This mathematical computation may be performed by controller module 932 of FIG. 9, which may take the form of instructions held in a storage device/subsystem of a mobile computing device and executed by a logic subsystem of that mobile computing device.

The above described methods and processes may be tied to a computing system including one or more computing devices. In particular, the methods and processes described herein may be implemented as one or more applications, service, application programming interfaces, computer libraries, and/or other suitable computer programs or instruction sets.

Referring again to FIG. 1 (and/or FIG. 4), which depicts an example computing system (e.g., electronic device 100) that may perform one or more of the above described methods and processes. Computing system is shown in simplified form. It is to be understood that virtually any computer architecture may be used without departing from the scope of this disclosure. Computing system or portions thereof may take the form of one or more of a mainframe computer, a server computer, a computing device residing on-board a vehicle, a desktop computer, a laptop computer, a tablet computer, a home entertainment computer, a network computing device, a mobile computing device, a mobile communication device, a gaming device, etc.

Computing system includes a logic subsystem and an information storage subsystem. Computing system may further include an input/output subsystem and a communication subsystem. Logic subsystem may include one or more physical devices configured to execute instructions, such as example instructions held in storage subsystem. For example, the logic subsystem may be configured to execute that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem includes one or more physical, non-transitory devices or machines, such as one or more processors, logic machines, etc. that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem includes one or more physical, non-transitory, devices configured to hold data in a data store and/or instructions executable by the logic subsystem to implement the herein described methods and processes. When such methods and processes are implemented, the state of storage subsystem may be transformed (e.g., to hold different data or other suitable forms of information).

Storage subsystem may include removable media and/or built-in devices. Storage subsystem may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Storage subsystem may include devices with one or more of the following characteristics: volatile, nonvolatile, dynamic, static, read/write, read-only, random access, sequential access, location addressable, file addressable, and content addressable. In at least some implementations, logic subsystem and storage subsystem may be integrated into one or more common devices, such as an application specific integrated circuit or a system on a chip.

It is to be appreciated that storage subsystem includes one or more physical, non-transitory devices. In contrast, in at least some implementations and under select operating conditions, aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module” or “program” may be used to describe an aspect of a computing system that is implemented to perform one or more particular functions. In some cases, such a module or program may be instantiated via logic subsystem executing instructions held by storage subsystem. It is to be understood that different modules or programs may be instantiated from the same application, service, code block, object, library, routine, API, function, etc. Likewise, the same module or program may be instantiated by different applications, services, code blocks, objects, routines, APIs, functions, etc. The terms “module” or “program” are meant to encompass individual or groups of executable files, data files, libraries, drivers, scripts, database records, etc.

It is to be appreciated that a “service”, as used herein, may be an application program or other suitable instruction set executable across multiple sessions and available to one or more system components, programs, and/or other services. In at least some implementations, a service may run on a server or collection of servers responsive to a request from a client.

Input/output subsystem may include and/or otherwise interface with one or more input devices and/or output devices. Examples of input devices include a keyboard, keypad, touch-sensitive graphical display device, touch-panel, a computer mouse, a pointer device, a controller, an optical sensor, a motion and/or orientation sensor (e.g., an accelerometer, inertial sensor, gyroscope, tilt sensor, etc.), an auditory sensor, a microphone, etc. Examples of output devices include a graphical display device, a touch-sensitive graphical display device, an audio speaker, a haptic feedback device (e.g., a vibration motor), etc. When included, a graphical display device may be used to present a visual representation of data held by storage subsystem. As the herein described methods and processes change the data held by the storage subsystem, and thus transform the state of the storage subsystem, the state of the graphical display may likewise be transformed to visually represent changes in the underlying data.

Communication subsystem may be configured to communicatively couple computing system with one or more other computing devices or computing systems. Communication subsystem may include wired and/or wireless communication devices compatible with one or more different communication protocols. As an example, the communication subsystem may be configured for communication via a wireless telephone network, a wireless local area network, a wired local area network, a wireless personal area network, a wired personal area network, a wireless wide area network, a wired wide area network, etc. In at least some implementations, the communication subsystem may enable computing system to send and/or receive messages to and/or from other devices via a communications network such as the Internet, for example.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof. It should be understood that the disclosed embodiments are illustrative and not restrictive. Variations to the disclosed embodiments that fall within the metes and bounds of the claims, now or later presented, or the equivalence of such metes and bounds are embraced by the claims.

1. A method for an electronic device, the method comprising:
obtaining a media content item including at least an audio component;
obtaining inertial sensor measurements indicating physical movement of the electronic device;
selecting a target tempo for presentation of the audio component, the target tempo based at least in part on the inertial sensor measurements; and
presenting at least a portion of the audio component via the electronic device at the target tempo while maintaining pitch of one or more frequency components of the portion of the audio component within a substantially un-shifted state relative to a native pitch of the one or more frequency components.

2. The method of claim 1, further comprising:
determining a native tempo of the portion of the audio component; and
wherein selecting the target tempo further includes:
determining a predominant cadence of a physical activity performed by a human subject based at least in part on the inertial sensor measurements; and
setting the target tempo to an integer multiple of the predominant cadence.

3. The method of claim 1, further comprising:
obtaining a user input indicating a user-defined target pace for a physical activity performed by a human subject; and
wherein selecting the target tempo includes:
determining a current pace for the physical activity performed by the human subject based at least in part on the inertial sensor measurements; and
increasing the target tempo if the current pace is less than the target pace while continuing to maintain pitch of one or more frequency components within the substantially un-shifted state relative to the native pitch of the one or more frequency components.

4. The method of claim 1, further comprising:
obtaining a user input indicating a user-defined target pace for a physical activity performed by a human subject; and
wherein selecting the target tempo includes:
determining a current pace for the physical activity performed by the human subject based at least in part on the inertial sensor measurements; and
decreasing the target tempo if the current pace is greater than the target pace while continuing to maintain pitch of one or more frequency components within the substantially un-shifted state relative to the native pitch of the one or more frequency components.

5. The method of claim 1, further comprising:
obtaining a predefined physical activity session indicating a target pace that varies over time for a physical activity performed by a human subject; and
wherein determining the target tempo includes:
determining a current pace for the physical activity performed by the human subject based at least in part on the inertial sensor measurements; and <varying the target tempo if current pace deviates from the target pace by more than a threshold amount, while continuing to maintain pitch of one or more frequency components within the substantially un-shifted state relative to the native pitch of the one or more frequency components.

6. The method of claim 1, further comprising:
processing the media content item at the electronic device to:
increase or decrease the native tempo toward the target tempo; and
maintain pitch by applying pitch correction to reduce deviations in pitch of the one or more frequency components relative to the native pitch that would otherwise be due to the increase or decrease of the native tempo toward the target tempo.

7. The method of claim 1, further comprising:
obtaining a media library including the media content item and one or more other media content items;
filtering the media library based at least in part on a respective native tempo of an audio component of each of the media content items of the media library to obtain a subset of the media content items having a respective native tempo within a tempo range of the target tempo; and
wherein obtaining the media content item includes selecting the media content item from the subset of media content items.

8. The method of claim 7, further comprising:
presenting a list of the subset of media content items via a graphical display of the electronic device; and
obtaining a user input directed at the list, the user input indicating a user-selection;
wherein selecting the media content item from the subset of media content items includes selecting the media content item indicated by the user-selection.

9. The method of claim 1, further comprising:
responsive to at least a threshold difference between the native tempo and the target tempo, adjusting pitch of the audio component away from the native pitch by an amount that is greater than the substantially un-shifted state but an amount that is less than a pitch deviation amount corresponding to the target tempo.

10. A storage subsystem having instructions stored thereon executable by a logic subsystem to:
obtain a media library including a plurality of media content items;
obtain a user input indicating a target tempo for presentation of an audio component of a media content item of the media library;
filter the media library based at least in part on a respective native tempo of an audio component of each of the media content items of the media library to obtain a subset of the media content items having a respective native tempo within a tempo range of the target tempo; and
present at least a portion of an audio component of a media content item of the subset via the electronic device at the target tempo and maintain pitch of one or more frequency components of the portion of the audio component within a substantially un-shifted state relative to a native pitch of the one or more frequency components during presentation of the audio component.

11. The storage subsystem of claim 10, wherein the instructions are further executable by the logic subsystem to:
obtain inertial sensor measurements indicating a current cadence of a physical activity performed by a human subject;
obtain a target cadence for the physical activity of the human subject;
vary the target tempo responsive to a deviation between the current cadence and the target cadence during presentation of the audio component, while continuing to maintain pitch of one or more frequency components within the substantially un-shifted state relative to the native pitch of the one or more frequency components.

12. The storage subsystem of claim 10, wherein the instructions are further executable by the logic subsystem to:
obtain the target cadence as a user-defined target cadence or a predefined physical activity session having a target cadence that varies over time.

13. A method for an electronic device, comprising:
receiving at least a portion of a media content item at the electronic device over a communications network;
selecting an augmented playback rate for the portion of the media content item that is less than a native playback rate of the portion of the media content item, the augmented playback rate selected responsive to a data rate of the communications network being less than a threshold data rate; and
presenting the portion of the media content item via the electronic device at the augmented playback rate while maintaining pitch of an audio component of the portion of the media content item within a substantially un-shifted state relative to a native pitch of the audio component.

14. The method of claim 13, further comprising:
selecting the native playback rate for the portion of the media content item responsive to the data rate of the communications network being greater than the threshold data rate; and
presenting the portion of the media content item via the electronic device at the native playback rate while maintaining pitch of an audio component of the portion of the media content item within a substantially un-shifted state relative to a native pitch of the audio component.

15. The method of claim 13, wherein the first operating condition corresponds to a data rate at which the media content item is received over the communication network being less than a threshold data rate; and
wherein the second operating condition corresponds to a data rate at which the media content item is received over the communication network being greater than the threshold data rate.

16. The method of claim 13, wherein the threshold data rate is based, at least in part, on one or more of:
an amount of data of the media content item already received at the electronic device over the communications network;
an amount of data of the media content item not yet received at the electronic device;
a data size of the media content item;
the data rate at which the media content item is received over the communications network;
learned data transmission behavior of the communications network from one or more previous sessions.

17. The method of claim 13, further comprising:
increasing an amount by which the playback rate of the media content item is reduced responsive to a decrease in a data rate of the communications network while receiving the media content item over the communications network.

18. The method of claim 13, further comprising:
presenting at least the portion of the media content item via the electronic device according to the altered playback mode responsive to a first operating condition; and
presenting at a least another portion of the media content item via the electronic device according to a native playback mode responsive to a second operating condition, the native playback mode corresponding to the native playback rate of the media content item and the native pitch of the audio component.
